(19) United States
(12) Patent Application Publication
(10) Pub. No.: US 2007/0052633 A1
(43) Pub. Date: Mar. 8, 2007

(54) Display device

(75) Inventors: Masatoshi Sato, Gifu (JP); Kazumasa Takai, Gifu (JP); Hitoshi Yasuda, Gifu (JP); Tomonori Matsumuro, Kyoto (JP)

Correspondence Address: MORRISON & FOERSTER LLP, 1650 TYSONS BOULEVARD, SUITE 300, MCLEAN, VA, 22102, US

(73) Assignee: SANYO ELECTRIC CO., LTD, Osaka (JP)

(21) Appl. No.: 11/511,506

(22) Filed: Aug. 29, 2006

(30) Foreign Application Priority Data
Aug. 30, 2005 (JP) 2005-249634

(51) Int. Cl. G09G 3/30

(52) U.S. Cl. 345/76

(57) ABSTRACT

The invention provides a display device that achieves optimization of an RGB signal without increasing power consumption required for displaying a test image. A display device of an embodiment of the invention has a display panel displaying an image corresponding to an RGB signal, a signal processing circuit portion including a plurality of signal processing circuits optimizing the RGB signal, an ACL circuit controlling the RGB signal so that the display panel emits light with predetermined electric power or less, and first and second test circuits respectively supplying first and second test image signals corresponding to first and second test images for the optimization to the display panel. The signal processing circuit portion further has a display area limitation circuit displaying the first and second test images only on a limited part as a display region of the display panel so that the whole of the display panel emits light with predetermined electric power or less when the first and second test image signals are supplied.

### CROSS-REFERENCE OF THE INVENTION

This invention is based on Japanese Patent Application No. 2005-249634, the content of which is incorporated herein by reference in its entirety.

### BACKGROUND OF THE INVENTION

1. Field of the Invention

The invention relates to a display device, particularly, a display device having a display panel using a self-emissive element as a light source and a control circuit controlling electric power of the display panel.

2. Description of the Related Art

In recent years, an organic electroluminescent (referred to as “EL”, hereafter) display device using an organic EL element as a self-emissive element has been developed as a color display device replacing a CRT or a LCD. Particularly, an active matrix type organic EL display device having a thin film transistor (referred to as a “TFT”, hereafter) as a switching element driving the organic EL element has been developed.

An organic EL display device of a conventional art will be described referring to figures next. FIG. 3 is a functional block diagram for explaining an organic EL display device of a conventional art. As shown in FIG. 3, the organic EL display device has a display panel 1 having a plurality of organic EL elements (not shown) self-emitting in response to a color display signal corresponding to each of colors R (red), G (green), and B (blue) (referred to as a “RGB signal”, hereafter), a signal processing portion DSP having signal processing circuits (not shown) (e.g. including a color correction circuit, a so-called gamma correction circuit or the like) optimizing the RGB signal to adjust the white balance or the like of the display panel 1, and a power supply circuit (not shown) supplying power to the display panel 1 and the signal processing portion DSP.

The signal processing portion DSP has a test circuit (not shown) supplying a test image signal corresponding to a test image for the optimization to the display panel. The signal processing portion DSP further has an ACL control (Automatic Contrast Limiter Control) circuit (not shown) controlling the RGB signal so that the display panel 1 can emit light with a predetermined electric power or less when the whole of the display panel 1 emits light with high luminance, that is, when the power consumption is large. The ACL circuit performs this control by, for example, calculating an integral value of the amplitude of the RGB signal for all the above colors and limiting the amplitude of the RGB signal so that the integral value does not exceed a predetermined value.

The optimization of the RGB signal is performed in the following manner, for example. First, a control signal φ for outputting a test image signal to the display panel 1 is outputted from a control device 2 such as a personal computer to a test circuit (not shown) of the signal processing portion DSP. Then, when a test image corresponding to the test image signal from the test circuit (not shown) is displayed on the display panel 1, optical characteristic values such as luminance or color temperature of the display panel 1 are measured by a luminance meter 3, and these measured data S is inputted to the control device 2. Different kinds of optimization value data C (e.g. a color correction value, a gamma characteristic value, or the like) are calculated based on the measured data S in the control circuit 2, and these optimization value data C are outputted to the signal processing portion DSP. The RGB signal is optimized with these optimization value data C in the signal processing portion DSP.

The measurement of the luminance or the like of the display panel 1 displaying the test image and the optimization of the RGB signal in the signal processing portion DSP are repeated until the desired optimization is completed.

The relevant technology is disclosed in the Japanese Patent Application Publication No. 2003-228328.

The test image used for the optimization of the RGB signal is generally displayed on the whole of the display panel as a white image made from the RGB signal. The power consumption required for displaying this test image is several times (e.g. about three to four times) as large as that required for displaying a normal color image. That is, the luminance of the display panel 1 is largely higher than that for displaying the normal image. Therefore, the integral value of the amplitude of the RGB signal is limited by the ACL circuit (not shown) so that the display panel 1 can emit light with the predetermined electric power or less.

However, since the optical characteristic values such as the luminance, the color temperature, or the like of the test image made from the RGB signal controlled by the ACL circuit differs from the values of the original test image, there is a problem that the optical characteristic values of the display panel 1 are not accurately measured. Furthermore, if such a control by the ACL circuit is stopped for avoiding the inaccurate measurement, the power consumption required for displaying the test image is very large as described above. Therefore, a power supply circuit (not shown) provided in the display device need be designed taking account of the power consumption highly larger than that required for displaying the normal image, thereby preventing the power saving of the display device.

### SUMMARY OF THE INVENTION

The invention provides a display device that achieves optimization of an RGB signal without increasing power consumption required for displaying a test image.

The display device of the invention includes: a display panel displaying an image corresponding to a color display signal; a signal processing circuit optimizing the color display signal; a control circuit controlling the color display signal so that the display panel emits light with predetermined electric power or less; a test circuit supplying a test image signal corresponding to a test image for the optimization to the display panel; and a display area limitation circuit displaying the test image only on a part of the display panel. The display panel includes a plurality of display pixels arrayed in a matrix, and a light source of each of the display pixels is a self-emissive element.

The display device of the invention achieves optimization of a color display signal without increasing power consumption required for displaying a test image. Therefore, the display device need not have a power supply circuit designed taking account of large power consumption required for displaying a test image as has been provided in the conventional art, but only has a power supply circuit designed taking account of power consumption required for displaying a normal image. This results in power saving of the display device.

### BRIEF DESCRIPTION OF THE DRAWINGS

FIG. 1 is a functional block diagram for explaining a display device of an embodiment of the invention.

FIG. 2 is a schematic plan view showing a display panel of the display device of the embodiment of the invention.

FIG. 3 is a functional block diagram for explaining an organic EL display device of a conventional art.

### DETAILED DESCRIPTION OF THE INVENTION

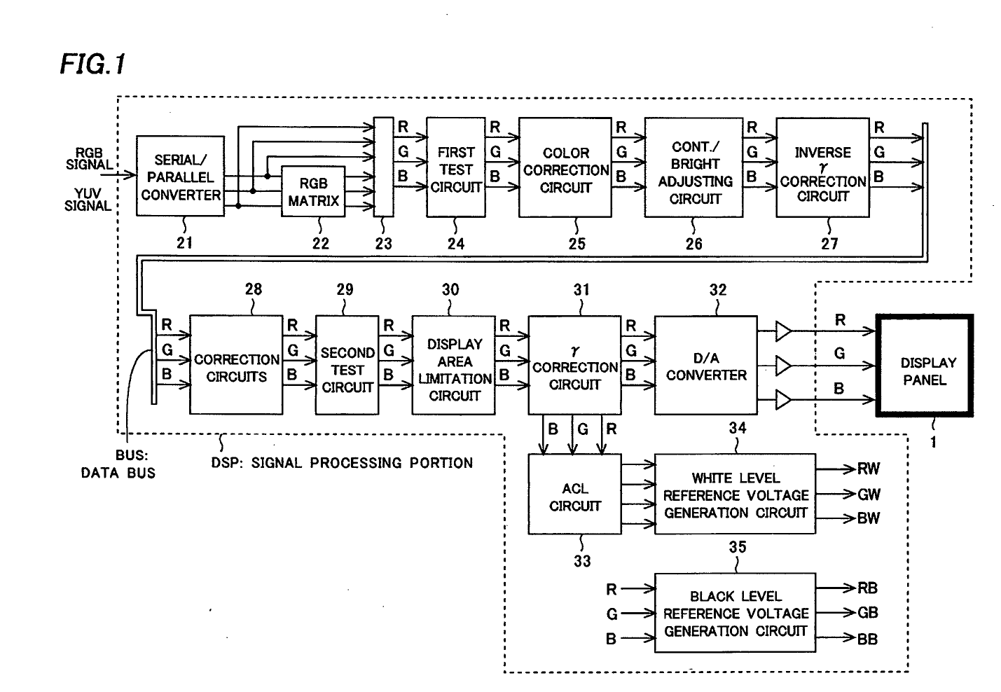

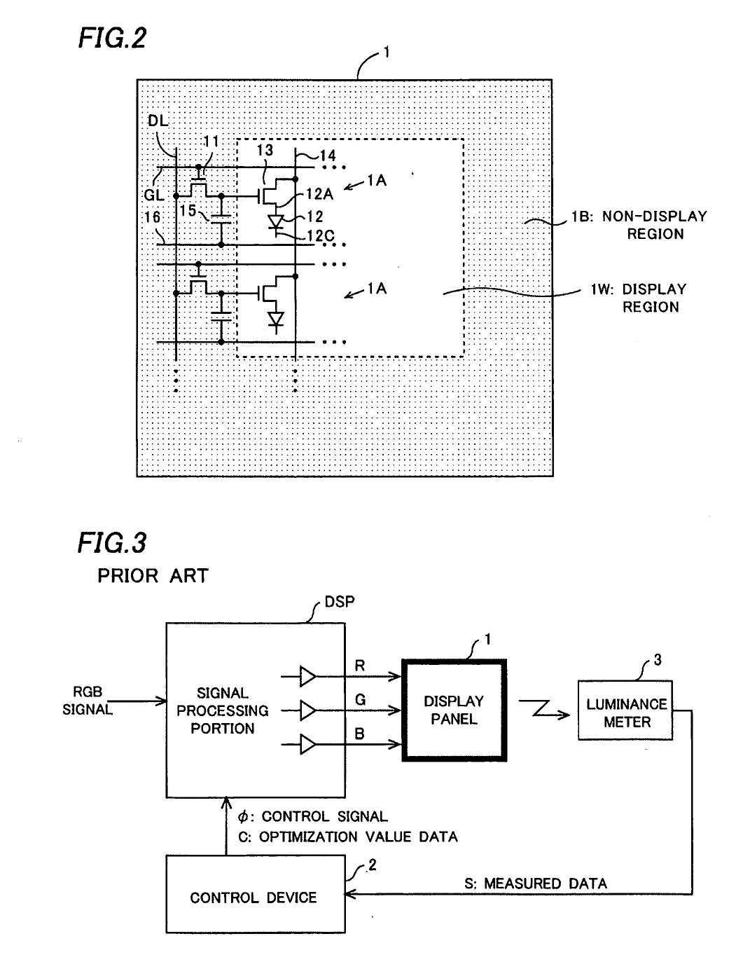

A structure of a display device of the invention will be described referring to figures. FIG. 1 is a functional block diagram for explaining the display device of an embodiment of the invention. FIG. 2 is a schematic plan view showing a display panel of the display device of the embodiment of the invention.

This display device has a plurality of display pixels 1A corresponding to each of colors, R (red), G (green), and B (blue) arrayed in a matrix, and a display panel 1 supplied with a color display signal corresponding to each of the colors (referred to as a “RGB signal”, hereafter), as shown in FIGS. 1 and 2. Each of the display pixels 1A has a pixel selection transistor 11 that turns on in response to a pixel selection signal, an organic EL element 12 as a self-emissive element having an anode 12A and a cathode 12C, a driving TFT 13 that is connected to a power supply line 14 and the anode 12A and drives an organic EL element 12 in response to the RGB signal supplied through the pixel selection TFT 11, and a storage capacitor 15 that is connected between a gate of the driving TFT 13 and a storage capacitor line 16 and holds an RGB signal for a predetermined period. The pixel selection signal is supplied from a vertical driving circuit (not shown) through a scanning line GL, and the RGB signal is supplied from a horizontal driving circuit (not shown) through a data line DL.

This display device further has a signal processing portion DSP including a plurality of signal processing circuits that optimizes a digitalized RGB signal to adjust the white balance or the like of the display panel 1.

This signal processing portion DSP has a serial/parallel converter 21. This serial/parallel converter 21 converts an RGB signal and a YUV signal including a luminance signal and a color-difference signal, that are serial signals, into parallel signals. The YUV signal that is one of these parallel signals is converted into an RGB signal by an RGB matrix 22. One of the RGB signal outputted from the serial/parallel converter 21 or the RGB signal converted from the YUV signal by the RGB matrix 22 is selected by a selection circuit 23, and outputted as the RGB signal for optimization. This RGB signal is inputted to a first test circuit 24. The first test circuit 24 outputs a first test image signal corresponding to a first test image of a predetermined color and pattern, that is a white image in this embodiment, based on the inputted RGB signal.

Then, the RGB signal for displaying a normal image or the RGB signal as a basis of a first test image signal is inputted to a color correction circuit 25 performing a predetermined color correction. The color corrected RGB signal is inputted to a Cont./Bright adjusting circuit 26 adjusting contrast or brightness. The RGB signal adjusted in its contrast or brightness is inputted to an inverse gamma (γ) correction circuit 27 that performs inverse gamma correction for turning its gamma (γ) characteristic curve into a straight line. The inverse gamma corrected RGB signal is inputted to different kinds of correction circuits 28 that perform different kinds of optical corrections to the RGB signal through a plurality of data buses BUS. These correction circuits 28 include a so-called sharpness circuit, an APL (Average Picture Level) correction circuit, or the like, for example. The RGB signal outputted from the correction circuit at the last stage of the different kinds of correction circuits 28 is inputted to the second test circuit 29. The second test circuit 29 outputs a second test image signal corresponding to a second test image of a predetermined color and pattern, i.e., a white image, based on the inputted RGB signal.

It is noted that the display device of this embodiment has the first and second testing circuits 24 and 29. The first testing circuit 24 generates the first test image signal based on the RGB signal prior to the signal processing performed at the circuits 25-28, and the second testing circuit 29 generates the second test image signal based on the RGB signal after the signal processing. The two testing circuits may be directed to different components of the display device, such as the driver ICs and the EL panel. Alternatively, they may be directed to the same device components to simply obtain a better optimization value data C.

Then, the RGB signal for displaying a normal image, the RGB signal as a basis of the first test image signal, or the RGB signal as a basis of the second test image signal is inputted to a display area limitation circuit 30. The display area limitation circuit 30 has a function of displaying the first or second test image only on a part of the display panel 1 so that the display panel 1 can display the test image within the predetermined power. The predetermined electric power means power corresponding to the luminance of the display panel 1, that is used as a reference when an ACL circuit 33 starts limiting the amplitude of the RGB signal as described below.

This display area limitation circuit 30 displays the first or second test image only on a part of the display panel 1 by, for example, masking a pixel selection signal applied to a scanning line (not shown) corresponding to a non-display region of the display panel 1 where the first or second test image is not displayed, an RGB signal applied to a data line (not shown) corresponding to the non-display region, or both of these signals, for example.

The RGB signal outputted from the display area limitation circuit 30 is inputted to a gamma correction circuit 31 that performs gamma correction to the RGB signal. The gamma corrected RGB signal is inputted to a D/A converter 32. The D/A converter 32 converts the RGB signal into an analog signal and outputs it to the display panel 1.

The gamma corrected RGB signal is inputted to the ACL circuit 33. The ACL circuit 33 controls the RGB signal so that the display panel 1 can emit light with the predetermined electric power or less when the whole display panel 1 emits light with high luminance, that is, when the power consumption is large.

The output signal of the ACL circuit 33 is inputted to a white level reference voltage generation circuit 34. The RGB signal outputted from the color correction circuit 25 is inputted to a black level reference voltage generation circuit 35. These white level reference voltage generation circuit 34 and black level reference voltage generation circuit 35 respectively output white level reference voltage values (voltage values corresponding to maximum values of luminance) RW, GW, and BW, and black level reference voltage values (voltage values corresponding to minimum values of luminance) RB, GB, and BB for each of the colors, that are used for D/A conversion, to the D/A converter 32.

Next, description will be given on an operation of the display device having the described structure, particularly, an operation for the optimization of the RGB signal using the first and second test images.

First, the serial/parallel converter 21 where an RGB signal and a YUV signal as serial digital signals are inputted outputs these input signals as parallel signals. The YUV signal that is one of these signals is converted into an RGB signal by the RGB matrix 22. Then, either one of the RGB signal outputted from the serial/parallel converter 21 or the RGB signal converted from the YUV signal by the RGB matrix 22 is selected by the selection circuit 23, and outputted as the RGB signal for optimization. Then, when a control signal φ having a predetermined signal activating the first test circuit 24 is outputted from the control device 2 such as a personal computer shown in FIG. 3 to the signal processing portion DSP, a first test image signal corresponding to a white image of a predetermined pattern as a first test image is generated by the first test circuit 24 based on the selected RGB signal.

Signal processing is performed to this first test image signal through the color correction circuit 25, the Cont./Bright adjusting circuit 26, the inverse gamma correction circuit 27, and the different kinds of correction circuits 28.

Then, the first test image signal is outputted to the display area limitation circuit 30 through the second test circuit 29 that is not operated. The first test image signal is masked in the display area limitation circuit 30 so as to be the first test image signal corresponding to a predetermined display region 1W that is a part of the display panel 1 as shown in FIG. 2. That is, the display area of the first test image is limited. The display region 1W that is a part of the display panel 1 has such a predetermined display area that electric power corresponding to the luminance of display panel 1 when the first test image is displayed is not controlled and limited by the ACL circuit. The other region than the display region 1W is shown as a non-display region 1B that does not emit light in FIG. 2.

Then, the first test image signal is outputted to the gamma correction circuit 31, and gamma correction is performed to this signal. The gamma corrected first test image signal is converted into an analog signal by the D/A converter 32, and displayed as a first test image only in the display region 1W that is a part of the display panel 1.

Then, optical characteristic values such as the luminance, the color temperature or the like of the display panel 1 where the first test image is displayed is measured by the luminance meter 3 shown in FIG. 3, and these measured values are outputted to the control device 2 as measured data S.

The optimization value data C necessary for optimizing the RGB signal by the color correction circuit 25, the Cont./Bright adjusting circuit 26, the inverse gamma correction circuit 27, and the different kinds of correction circuits 28 are generated based on the measured data S by the control device 2, and outputted to the signal processing portion DSP. The optimization is performed based on the optimization value data C in each of the signal processing circuits of the signal processing portion DSP.

In the measurement and optimization, since the display region of the first test image is limited by the display area limitation circuit 30, the luminance of the display panel 1 does not become a value controlled by the ACL circuit 33. Therefore, the RGB signal as a basis of the first test image signal is not controlled by the ACL circuit 33, and measured while keeping its original optical characteristics. Therefore, the optimization value data C based on the measured data S also becomes an accurate value based on its original RGB signal, and the accurate optimization of the RGB signal can be performed compared with the conventional art.

Furthermore, the power consumption required for displaying the first test image does not exceed the power consumption for displaying a normal image. Therefore, the power supply circuit (not shown) of the display device is not necessarily designed taking account of large power consumption required for displaying the test image as has been seen in the conventional art, but only designed taking account of the power consumption for displaying the normal image. This enables power saving of the display device.

Then, when a control signal φ having a predetermined signal activating the second test circuit 29 is outputted from the control device 2 to the signal processing portion DSP, a second test image signal corresponding to the second test image is generated by the second test circuit 29 instead of by the first test circuit 24 in the same manner as the case of the first test image. This second test image signal is generated based on the RGB signal in the same manner as the case of the first test image signal.

The second test image signal is outputted to the display area limitation circuit 30. At this time, the second test image signal is masked so as to be the second test image signal corresponding to the predetermined display region 1W that is a part of the display panel 1 in the same manner as the case of the first test image signal. That is, the display area of the second test image is limited.

This second test image signal is outputted to the gamma correction circuit 31 and gamma corrected. Then, the second test image corresponding to the second test image signal turned into an analog signal by the D/A converter 32 is displayed only in the display region 1W that is a part of the display panel 1. At this time, too, electric power corresponding to the luminance of the display panel 1 is not controlled by the ACL circuit 33 in the same manner as the case of displaying the first test image.

Next, the measurement of the optical characteristic values such as the luminance, the color temperature or the like of the display panel 1, and the optimization of the RGB signal are performed in the same manner as the case of displaying the first test image. The measurement and optimization using this second test image is repeated by outputting the control signal φ from the control device 2 as appropriate until the RGB signal is optimized to the desired extent. This case also has the same effect as the above-described measurement and optimization using the first test image. That is, the RGB signal can be accurately optimized without consuming larger power for displaying the second test image than for displaying a normal image.

Although the light source of the display panel 1 is an organic EL element in the described embodiment, the invention is not limited to this. That is, the invention can be also applied to the other self-emissive element than the organic EL element, for example, to a case where an inorganic EL element or the like is used as a light source of a display panel.

Furthermore, the signal processing portion DSP of the embodiment may include the other signal processing circuits or the like as long as it has the same effect.

What is claimed is:

1. A display device comprising:
a display panel displaying an image corresponding to a color display signal;
a signal processing circuit optimizing the color display signal;
a test circuit supplying to the display panel a test image signal corresponding to a test image for the optimization; and
a display area limitation circuit having the test image to be displayed only on a portion of the display panel.

2. The display device of claim 1, further comprising a control circuit controlling the color display signal so that the display panel emits light within a predetermined power, wherein the display device is configured so that the display of the test image on the portion of the display panel is performed within the predetermined power.

3. The display device of claim 1, wherein the display panel comprises a plurality of display pixels arrayed in a matrix, and a light source of each of the display pixels comprises a self-emissive element.

4. The display device of claim 2, wherein the display panel comprises a plurality of display pixels arrayed in a matrix, and a light source of each of the display pixels comprises a self-emissive element.

5. The display device of claim 3, wherein the self-emissive element is an organic electroluminescent element.

6. The display device of claim 4, wherein the self-emissive element is an organic electroluminescent element.

7. The display device of claim 1, wherein the test image is a white pattern made from the color display signal.

8. The display device of claim 2, wherein the test image is a white pattern made from the color display signal.

9. The display device of claim 3, wherein the test image is a white pattern made from the color display signal.

10. The display device of claim 4, wherein the test image is a white pattern made from the color display signal.

11. The display device of claim 5, wherein the test image is a white pattern made from the color display signal.

12. The display device of claim 6, wherein the test image is a white pattern made from the color display signal.
